(19) United States
(12) Patent Application Publication
(10) Pub. No.: US 2009/0313455 A1
(43) Pub. Date: Dec. 17, 2009

(54) Instruction issue control wtihin a multithreaded processor

(76) Inventors: David Hennah Mansell, Cambridge (GB); Stuart David Biles, Little Thurlow (GB)

Correspondence Address: NIXON & VANDERHYE, PC, 901 NORTH GLEBE ROAD, 11TH FLOOR, ARLINGTON, VA, 22203, US

(21) Appl. No.: 11/919,210

(22) PCT Filed: Dec. 15, 2005
(86) PCT No.: PCT/GB2005/004859

§ 371 Date: Oct. 25, 2007

(51) Int. Cl. G06F 9/38

(52) U.S. Cl. 712/207; 712/E09.062

(57) ABSTRACT

A multithreaded processor is provided with a saturating counter which serves to generate a thread preference signal to steer selection of which program thread operations are taken from for issue into the multiple processor pipelines. The counter is updated based upon the selections made for issue. The counter is a saturating counter and its sign bit may be used as a thread preference signal when discriminating between two threads. The update made to the count value can be weighted depending upon programmable priorities associated with the respective threads as well as a weighting based upon the time taken to execute the type of operation selected.

This invention relates to the field of multithreaded processors. More particularly, this invention relates to the control of instruction issue in multithreaded processors.

A variety of multithreaded processors are known. A multithreaded processor is able to execute program instructions from multiple program threads in parallel. One advantage of such processors is that, if the program instructions of one program thread are stalled or delayed for some reason, then program instructions from another thread can be issued and executed to make better use of the processor resources. Advanced high performance multithreaded processors can support out-of-order techniques in which program instructions can be executed out-of-order within their individual threads if this is determined to be possible and more efficient. Sophisticated buffering and control techniques are sometimes used to control instruction issue and thread prioritisation within such out-of-order multithreaded processors.

Whilst the advanced, high performance multithreaded processors mentioned above are able to obtain an instruction throughput advantage through the use of such techniques, the associated overhead in terms of circuit complexity, cost, power consumption and the like is a disadvantage. Accordingly, it is desirable to have less complex multithreaded processors which are able to yield a large portion of the advantages associated with multithreading with lower overhead and expense. It is also desirable that such processors should be able to provide a prioritisation mechanism whereby program instructions from differing program threads can have different priorities associated with them and instruction issue can be controlled to reflect that priority. In this way, a most performance critical thread can be given a high priority and yet can be prevented from monopolising all of the processing time and completely stopping the other threads from executing.

A known prioritisation scheme is that used in the TriCore 2 processor produced by Infineon. This uses a timer-based priority scheme in which a timer is run and establishes at each issue point which thread is to be given priority. Thus, in an example with two program threads running, the first of these may be given priority for two time units and the second for one time unit with priority then returning to the first thread for a further two time units and so on. Whilst this approach is relatively simple to implement, it suffers from the disadvantage that during the time period when a particular program thread is given its priority, other factors, such as instruction interlocks, memory access delays and the like, may prevent program instructions from that thread actually being issued and executed. By the time that such delays are removed, the timer may have moved on and the priority for that thread may have been removed. Thus, a higher priority thread may not actually achieve greater program instruction issue.

Viewed from one aspect the present invention provides a multithreaded processor for executing instructions from a plurality of program threads, said multithreaded processor comprising:

one or more instruction pipelines each having a plurality of pipeline stages including at least one steered stage; and

a thread preference unit operable to generate a thread preference signal input to said at least one steered stage to influence selection of from which program threads operations are selected to progress from said at least one steered stage along said one or more instruction pipelines; wherein

said thread preference unit generates said thread preference signal in dependence upon from which programs threads preceding operations were selected to progress by said at least one steered stage.

The thread preference unit of the present technique is responsive to from which program threads operations were selected to be steered along the pipelines when updating the thread preference signal. Thus, if a high priority thread for some reason is not able to issue its operations for some time, then program operations from a lower priority thread will be issued, but the thread preference signal will be responsive to the fact that the high priority thread operations have not issued and maintain the thread preference signal as indicating that they should be issued when possible. Making the said preference signal responsive to the actual selections made at the steered stage produces a result which more accurately reflects the priorities associated with the differing program threads.

Whilst it will be appreciated that the steered stage could occur in a variety of positions within an instruction pipeline and an instruction pipeline may contain multiple steered stages at different points along its length, the technique is particularly suited to embodiments in which the steered stage is an issue stage operable to control issue of operations for execution in one or more following pipeline stages. At the issue stage decoding of the instructions can have occurred such that the system can determine which operations are capable of being issued at a particular time and then the thread preference superimposed upon the hard constraints of which operations are actually available for issue.

Implementation is eased when program operations from the multiple threads are supplied as inputs to the issue stage such that appropriate selection and multiplexing of program operations for progress along the following stages in the multiple pipelines can be made.

The present technique is particularly well suited to an in-order processor where it is complementary to the design objectives of typical in-order processors, i.e. simplicity, low power consumption, low cost and the like have been preferred over a higher absolute level of performance that may be achieved with an out-of-order processor.

Within a system in which it is desired to issue operations selected from two program threads responsive to a priority level associated with those threads, then preferred embodiments can use a selection counter to which a value is added when an operation from the first thread is issued and from which a value is subtracted when an operation from the second thread is issued. The value stored in the selection counter can then be compared with a threshold value and depending upon whether or not the count is above or below this threshold value the appropriate preference signal for the next selections to be made can be generated. Variation of the values added to and subtracted from the selection counter in dependence upon the relative priorities of the threads concerned as well as the nature of the operations actually issued (e.g. a slow load multiple operation would have a higher weighting than a fast logical operation) can be optionally provided. In alternative embodiments capable of supporting multiple program threads, a counter may be associated with each thread with additions and subtractions from the count values being made in dependence upon which operation is selected at each point in time and a comparison of the count values being made in order to determine the thread preference signal to be asserted at each point in time. This approach may also accommodate relative thread weightings and operation weightings if desired.

Saturating counters may advantageously be used as these will not overflow and may be advantageously small as well as having the advantage of reaching a saturated level and not progressing beyond that level in a way which prevents thread preference being abnormally distorted. The threshold value associated with such saturating counters can advantageously be set to zero such that a positive sign bit can indicate one thread selection and a negative sign bit can indicate a different thread selection.

Viewed from another aspect the present invention provides a multithreaded processor for executing instructions from a plurality of program threads, said multithreaded processor comprising:

one or more instruction pipeline means each having a plurality of pipeline stages including at least one steered stage; and

a thread preference means for generating a thread preference signal input to said at least one steered stage to influence selection of from which program threads operations are selected to progress from said at least one steered stage along said one or more instruction pipeline means; wherein

said thread preference means generates said thread preference signal in dependence upon from which programs threads preceding operations were selected to progress by said at least one steered stage.

Viewed from a further aspect the present invention provides a method of executing instructions from a plurality of program threads using one or more instruction pipelines each having a plurality of pipeline stages including at least one steered stage, said method comprising the steps:

generating a thread preference signal input to said at least one steered stage to influence selection of from which program threads operations are selected to progress from said at least one steered stage along said one or more instruction pipelines; wherein

generation of said thread preference signal is dependent upon from which programs threads preceding operations were selected to progress by said at least one steered stage.

Embodiments of the invention will now be described, by way of example only, with reference to the accompanying drawings in which:

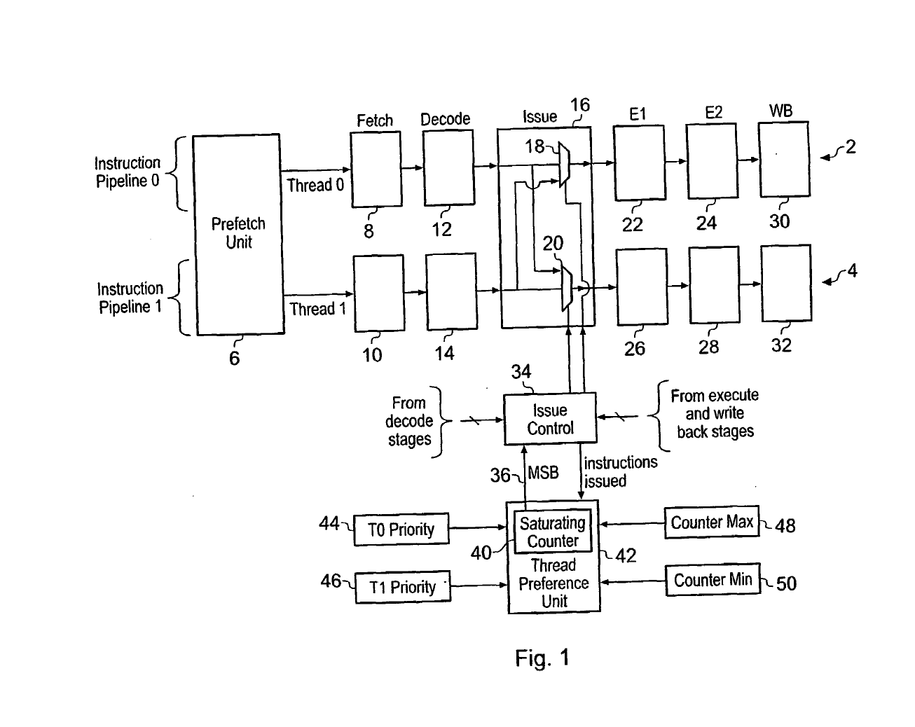

FIG. 1 schematically illustrates instruction pipelines within a multithreaded processor;

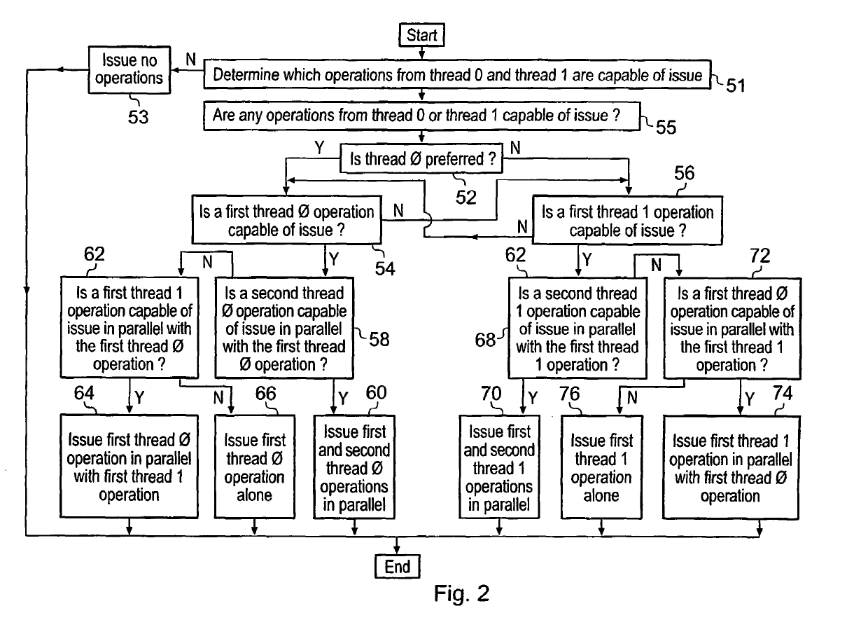

FIG. 2 is a flow diagram schematically illustrating the control of issue in accordance with the embodiment of FIG. 1 as steered by a thread preference signal;

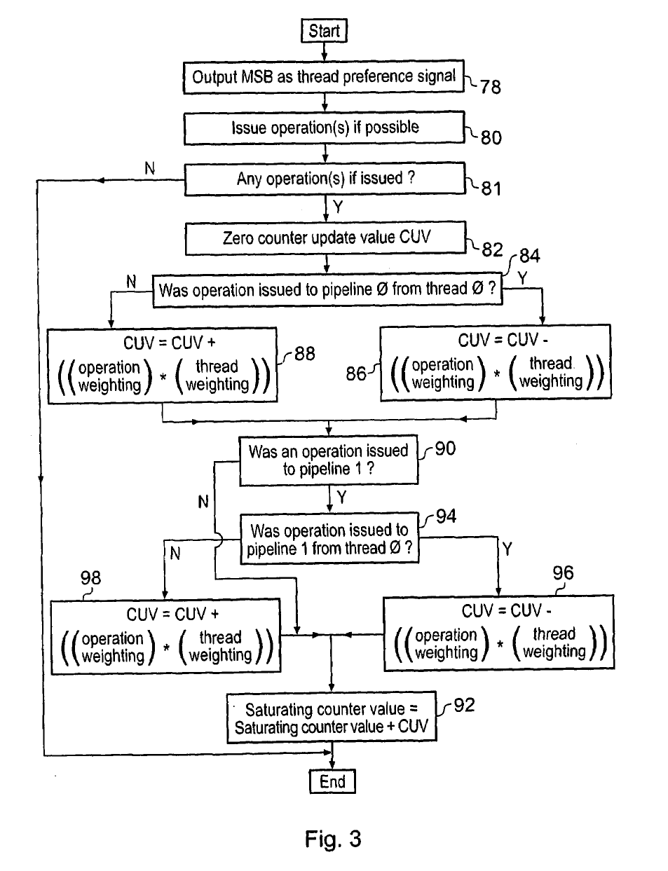

FIG. 3 is a flow diagram schematically illustrating an example of how the thread preference signal of FIGS. 1 and 2 may be updated;

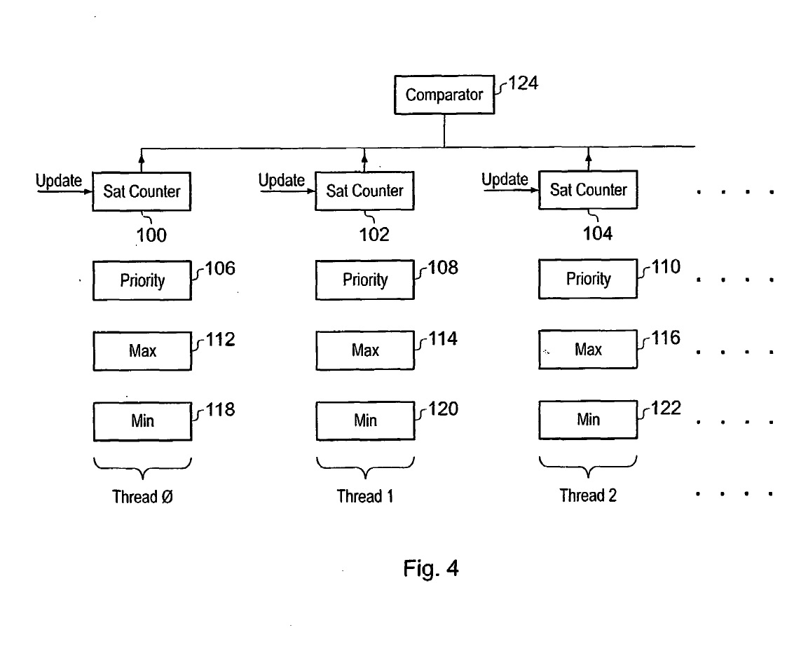

FIG. 4 is a diagram schematically illustrating a different thread preference unit incorporating multiple selection counters; and

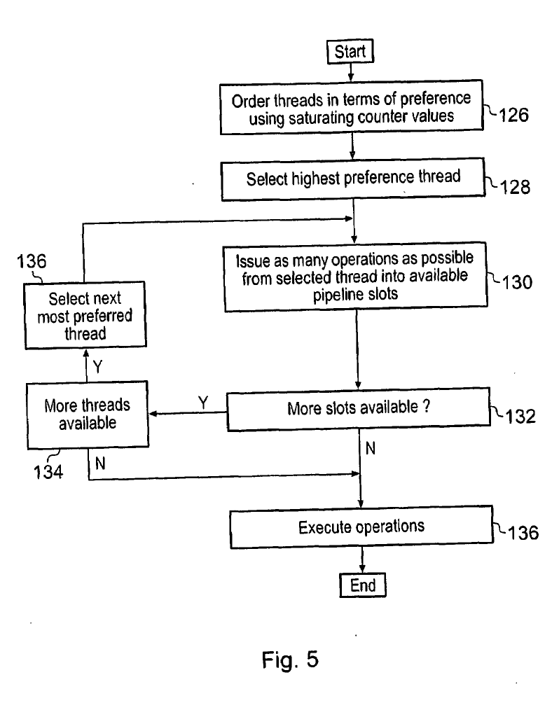

FIG. 5 is a flow diagram schematically illustrating an alternative generic technique of issue control.

FIG. 1 shows the instruction pipelines 2, 4 within an in-order multithreaded processor. A prefetch unit stage 6 is followed by respective fetch stages 8, 10 and respective decode stages 12, 14 before the control signals corresponding to operations from the two different program threads are supplied as inputs to an issue stage 16. The multiplexers 18, 20 within the issue stage 16 are able to select the output of either of the decode stages 12, 14 to progress further along their respective pipelines through the execution stages 22, 24, 26, 28 and the writeback stages 30, 32. The issue stage 16 can select: two operations from thread 0; two operations from thread 1; one operation from thread 0; one operation from thread 1; or one operation from each thread, to be executed in the subsequent pipeline stages.

An issue control unit 34 serves to control the multiplexers 18, 20 in dependence upon signals received from the decode stages 12, 14 and from the executing and writeback stages 22 to 32 in dependence upon known techniques for multiple issue processors, such as score boarding and the like, which take account of dependencies between operations. The function of the issue control unit 34 in determining which operations from the multiple threads are capable of issue at a given time is augmented with a thread preference signal 36, which in this case comprises the most significant bit of a saturating counter 40 within a thread preference unit 42. The use of this thread preference signal 36 in combination with a determination of which program operations are capable of execution will be discussed further below.

The issue control unit 34 feeds back to the thread preference unit 42 an indication of which instructions (fast/slow) were issued from which thread and the thread preference unit 42 then computes a counter update value which is a value to be added to or subtracted from the value stored within the saturating counter 40. This counter update value takes account of the thread(s) from which operations were selected for issue by the issue stage 16 as well as the nature of those operations (e.g. whether they are slow or fast) and the priority weighting of the thread concerned (e.g. a high priority or a low priority). Thus, if the count value generates a thread preference signal corresponding to a first thread, then if the operations are issued from that first thread, but are fast operations and the first thread is a high priority thread, then the count value will be updated so as to influence the thread preference signal away from that first thread by a relatively small amount. Conversely, if the first thread is of a low priority and the operation selected was a slow instruction, then the count value will be updated by an amount which more strongly moves the thread preference signal away from the first thread. It will be appreciated that in this example embodiment the thread preference signal is effectively a binary value and the degree of preference for a particular thread is expressed by the count value within the saturating counter 40 at any particular time. If the count value is positive, corresponding to a most significant bit being zero, then the first thread will be preferred. Conversely, if the count value is negative corresponding to the most significant bit being a one, then the second thread will be preferred. The relative priority levels associated with the threads may be programmed under software control into priority value registers 44, 46 to influence the weighting given to each thread by virtue of the counter update values associated with an operation from that thread being executed. As an option, programmable counter maximum and minimum values may be set up using registers 48, 50 and also serve to influence the relative priorities between the two threads when the sign bit of the saturating counter is being used. When the saturating value reaches either the maximum or minimum value it will not progress beyond that value irrespective of what counter update value is generated corresponding to the operation selected since the count will have saturated in accordance with the normal behaviour of saturating counters. The programmable maximum and minimum counter values may be omitted in other embodiments and the saturation points based upon the size of the saturating counter, e.g. a 6-bit two's complement signed counter can express values in the range from −32 to +31 and so would saturate at these values.

FIG. 2 is a flow diagram schematically illustrating the operation of the issue control unit 34. At step 51 a determination is made as to which operations from thread 0 and thread 1 are capable of issue in the current cycle. This determination can be made using signals from the decode, execute and writeback stages concerning operation dependencies, interlock, stalls the like. At step 55 a decision is made based on whether any operations from thread 0 or thread 1 are capable of issue. If there are no operations capable of issue then the process proceeds via step 53 to the end. Otherwise processing proceeds to step 52. At step 52 the thread preference signal 36 is examined and it is determined whether thread 0 is preferred. If thread 0 is preferred, then processing proceeds to step 54 at which a decision is made based on whether there is a first thread 0 operation capable of issue. If no thread 0 operation is available, then processing proceeds to step 56. If a thread 0 operation is available, then processing proceeds to step 58 where a decision is made based on whether or not a second thread 0 operation is capable of issue in parallel with the first thread 0 operation. If such parallel issue of two thread 0 operations is possible, then this is performed at step 60 by generation of appropriate signals from the issue control unit 34 to the multiplexers 18, 20 at step 60. If a second thread 0 operation is not capable of issuing in parallel with the first thread 0 operation as decided at step 58, then step 62 decides whether a first thread 1 operation is capable of issue in parallel with the first thread 0 operation. If it is possible to issue a first thread 1 operation in parallel with the first thread 0 operation, then this is performed at step 64 by appropriate control of the multiplexers 16, 18. If only the first thread 0 operation is capable of issue at this time, then this is performed at step 66.

If the determination at step 52 was that thread 0 was not preferred or the decision at step 54 was that there were no thread 0 operations capable of issue, then step 56 acts to decide whether a first thread 1 operation is capable of issue. If a first thread 1 operation is capable of issue, then processing proceeds to step 68 and a decision is made of whether a second thread 1 operation is capable of issue in parallel with the first thread 1 operation. If parallel issue of two thread 1 instructions is possible, then this is performed at step 70. Alternatively, a decision at step 72 is made as to whether or not a first thread 0 operation can be issued in parallel with the first thread 1 operation. If this is possible, then it is performed at step 74, otherwise step 76 issues the single thread 1 operation.

FIG. 3 is a flow diagram schematically illustrating the updating of the saturating counter 40 within the thread preference unit 42. At step 78 the most significant bit from the saturating counter 40 (a sign bit) is output as a thread preference signal 36 to the issue control unit 34. At step 80 the issue control unit 34 issues, if possible, the desired operations in accordance with steps 64, 66, 60, 70, 76 and 74 of FIG. 2. If the determination at step 51 of FIG. 2 was that no operations are capable of issue, then step 81 identifies this and terminates processing, otherwise processing proceeds to step 82. At step 82 the counter update value CUV from the previous pass through the flow of FIG. 3 is zeroed and processing proceeds to step 84 at which a determination is made as to whether or not the operation issued into pipeline 0 was from thread 0. If the operation was from thread 0, then at step 86 the counter update value is updated by subtracting from it a value determined by an operation weighting multiplied by a thread weighting. The thread weighting can be determined from the priority register 44 for thread 0. The operation weighting can be determined based upon the inputs from the decode stages indicating whether or not the operation issued in pipeline 0 was slow or fast. As an example, a logical operation may have an operation weighting rating of 1 whereas a load multiple instruction may have an operation weighting of 5. Updating the counter update value in accordance with thread 0 operations being issued by subtracting from the counter update value has the effect that when the counter update value is added to the current value within the saturating counter 40, that current value will be reduced. It will be appreciated that positive values of the count value within the saturating counter 40 (most significant bit being 0) are the ones which indicate a thread preference signal selecting thread 0. Accordingly, when operations from thread 0 are issued the count value should be reduced taking it towards negative values which will tend to favour issue of operations from thread 1.

If the determination at step 84 was that the operation issued to pipeline 0 was not from thread 0, then step 88 serves to update the counter update value again based upon an operation weighting multiplied by thread weighting but in this case added to the counter update value so tending to make the saturating counter become more positive.

At step 90 a determination is made as to whether or not an operation was issued into pipeline 1. It is possible that only a single operation was issued at step 80 (corresponding to steps 66 and 76 in FIG. 2) and if this is the case, then processing proceeds to step 92 where the saturating counter is updated with the current counter update value.

If an operation was issued into pipeline 1, then step 94 determines whether or not this was from thread 0. If the operation issued into pipeline 1 was from thread 0, then step 96 serves to update the counter update value in accordance with an operation and thread weighting in a manner which reduces the counter update value and so will tend to reduce the count value within the saturating counter 40. Conversely, if the determination at step 94 was an operation not from thread 0, then step 98 serves to update the counter update value but making it more positive. Finally, at step 92 the saturating counter is updated, subject to saturation of the result as provided by the nature of the saturating counter, with the counter update value which has been subject to processing at either step 86 or step 88, and optionally at steps 96 or 98. The saturating values are determined by the maximum and minimum value registers 48, 50, or if these are omitted by the bit size of the saturating counter itself. It will be appreciated that the determinations at step 84 and step 90 are as to what operations were actually issued into the two pipeline stages at step 80. It may be that the operations which were issued at step 80 were contrary to the thread preference signal 36 which was being asserted at that time, but was not able to be followed due to interlocks or other constraints. Updating the saturating counter dependent upon the actual selections which were made produces a fairer and more responsive control of the thread preference signal and accordingly more accurate and responsive prioritisation between the threads.

FIG. 4 illustrates a second embodiment in which multiple saturating counters 100, 102, 104 are provided, each corresponding to a different program thread. Each of these saturating counters has a programmable priority register 106, 108, 110, maximum value register 112, 114, 116 and minimum value register 118, 120, 122. The maximum value register 112, 114, 116 and the minimum value register 118, 120, 122 may alternatively be omitted and saturation controlled by the bit size of the saturating counter 100, 102, 104. In one example implementation when an operation is issued from thread 0 then the saturating counter for thread 0 is decremented by a value dependent upon the priority value programmed for thread 0 and the operation weighting of the operation actually issued subject to the maximum and minimum values set for the counter 100. The remaining saturating counters 102 and 104 are each incremented by a value corresponding to half the value which has been decremented from counter 100. Thus, the change in the sum of count values held in saturating counters 100, 102 and 104 is zero. This updating is performed in respect of each operation issued. As an example, if operations are issued from thread 0 and thread 2, but not from thread 1, then the saturating counter for thread 1 will only be subject to increases in its value making it more likely that it will have the highest value when the count values within the saturating values 100, 102 and 104 are subsequently compared.

When generating a thread preference signal to control issue at any particular time, the comparator 124 compares the count values within the saturating values 100, 102 and 104 to identify the highest and this is the thread which is indicated as preferred by the thread preference signal.

The example of FIG. 4 has been described in the context of the highest value held within one of the saturating counters 100, 102 and 104 as indicating that the corresponding thread should have its operations preferred. It is also possible to invert the meaning of the counters such that the lowest count value will correspond to the highest priority. In this case, operations issued from a thread will result in increases to the count value associated with that thread and decreases to the count values associated with the other threads.

FIG. 5 is a flow diagram schematically illustrating a more generic way of operating an issue control unit. At step 126 a determination is made which places the threads in order of preference using their respective saturating counter values as illustrated in FIG. 4. At step 128 the highest preference thread is selected. Step 130 then issues as many operations as possible from that selected thread into available pipeline slots. This issue at step 130 is subject to interlock checks, data dependency checks, memory access stall checks and the like as is normal with multiple issue systems. At step 132 a determination is made as to whether more pipeline slots are available into which operations could be issued. If more slots are available, then step 134 determines whether or not more threads are available from which to take operations. If more threads are available, then step 136 selects the next highest preference thread and processing is returned to step 130. If no more threads are available at step 134 or no more slots are available at step 132, then processing proceeds to step 136 at which the operations issued into the pipeline slots are executed.

1. A multithreaded processor for executing instructions from a plurality of program threads, said multithreaded processor comprising:
one or more instruction pipelines each having a plurality of pipeline stages including at least one steered stage; and
a thread preference unit operable to generate a thread preference signal input to said at least one steered stage to influence selection of from which program threads operations are selected to progress from said at least one steered stage along said one or more instruction pipelines; wherein
said thread preference unit generates said thread preference signal in dependence upon from which programs threads preceding operations were selected to progress by said at least one steered stage.

2. A multithreaded processor as claimed in claim 1, wherein said at least one steered stage is an issue stage operable to control issue of operations for execution in one or more following pipeline stages.

3. A multithreaded processor as claimed in as claimed in claim 2, wherein operations from a plurality of program threads are supplied as inputs to said instruction issue stage.

4. A multithreaded processor as claimed in claim 2, wherein said issue stage selects one or more operations for issue to respective ones of a plurality of pipelines stages of respective instruction pipelines.

5. A multithreaded processor as claimed in claim 1, wherein said multithreaded processor is an in-order multithreaded processor.

6. A multithreaded processor as claimed in claim 1, wherein said plurality of program threads comprise a first program thread and a second program thread and said thread preference unit comprises a selection counter operable to store a count value, said thread preference unit adding an increment value to said count value when an operation from said first program thread is selected and subtracting a decrement value from said count value when an operation from said second program thread is selected and said thread preference unit generating a thread selecting signal to steer selection of an operation of said second thread when said count value is above a threshold value and to steer selection of an operation of said second thread when said count value is below said threshold value.

7. A multithreaded processor as claimed in claim 1, wherein said thread preference unit comprises a plurality of selection counters, one for each of said plurality of program threads and each operable to store a count value for a respective program thread, said thread preference unit adding an increment value to a count value for a selected program thread when an operation from said selected program thread is selected and subtracting a decrement value from each of said count values for those program threads from which an operation is not selected, and said thread preference unit generating a thread selecting signal to steer selection of an operation in dependence upon which program thread has a lowest count value.

8. A multithreaded processor as claimed in claim 1, wherein said thread preference unit comprises a plurality of selection counters, one for each of said plurality of program threads and each operable to store a count value for a respective program thread, said thread preference unit subtracting an decrement value from a count value for a selected program thread when an operation from said selected program thread is selected and adding an increment value to each of said count values for those program threads from which an operation is not selected, and said thread preference unit generating a thread selecting signal to steer selection of an operation in dependence upon which program thread has a highest count value.

9. A multithreaded processor as claimed in claim 6, wherein said threshold value is zero.

10. A multithreaded processor as claimed in claim 6, wherein said selection counter is a saturating counter having a maximum value and a minimum value between which said count value can vary without overflow.

11. A multithreaded processor as claimed in claim 6, wherein said increment value and said decrement value are dependent upon software controlled thread priority values.

12. A multithreaded processor as claimed in claim 6, wherein said increment value and said decrement value are dependent upon at least what type of operation was selected by said at least one steered stage.

13. A multithreaded processor as claimed in claim 7, wherein said plurality of selection counters are a plurality of saturating counters.

14. A multithreaded processor for executing instructions from a plurality of program threads, said multithreaded processor comprising:
one or more instruction pipeline means each having a plurality of pipeline stages including at least one steered stage; and
a thread preference means for generating a thread preference signal input to said at least one steered stage to influence selection of from which program threads operations are selected to progress from said at least one steered stage along said one or more instruction pipeline means; wherein
said thread preference means generates said thread preference signal in dependence upon from which programs threads preceding operations were selected to progress by said at least one steered stage.

15. A method of executing instructions from a plurality of program threads using one or more instruction pipelines each having a plurality of pipeline stages including at least one steered stage, said method comprising the steps:
generating a thread preference signal input to said at least one steered stage to influence selection of from which program threads operations are selected to progress from said at least one steered stage along said one or more instruction pipelines; wherein
generation of said thread preference signal is dependent upon from which programs threads preceding operations were selected to progress by said at least one steered stage.

16. A method as claimed in claim 15, wherein said at least one steered stage is an issue stage operable to control issue of operations for execution in one or more following pipeline stages.

17. A method as claimed in claim 16, wherein operations from a plurality of program threads are supplied as inputs to said issue stage.

18. A method as claimed in claim 16, wherein said issue stage selects one or more operations for issue to respective ones of a plurality of pipelines stages of respective instruction pipelines.

19. A method as claimed in claim 15, wherein said method is an in-order method.

20. A method as claimed in claim 15, wherein said plurality of program threads comprise a first program thread and a second program thread and said thread preference unit comprises a selection counter operable to store a count value, said thread preference unit adding an increment value to said count value when an operation from said first program thread is selected and subtracting a decrement value from said count value when an operation from said second program thread is selected and said thread preference unit generating a thread selecting signal to steer selection of an operation of said second thread when said count value is above a threshold value and to steer selection of an operation of said second thread when said count value is below said threshold value.

21. A method as claimed in claim 15, wherein said thread preference unit comprises a plurality of selection counters, one for each of said plurality of program threads and each operable to store a count value for a respective program thread, said thread preference unit adding an increment value to a count value for a selected program thread when an operation from said selected program thread is selected and subtracting a decrement value from each of said count values for those program threads from which an operation is not selected, and said thread preference unit generating a thread selecting signal to steer selection of an operation in dependence upon which program thread has a lowest count value.

22. A method as claimed in claim 15, wherein said thread preference unit comprises a plurality of selection counters, one for each of said plurality of program threads and each operable to store a count value for a respective program thread, said thread preference unit subtracting an decrement value from a count value for a selected program thread when an operation from said selected program thread is selected and adding an increment value to each of said count values for those program threads from which an operation is not selected, and said thread preference unit generating a thread selecting signal to steer selection of an operation in dependence upon which program thread has a highest count value.

23. A method as claimed in claim 20, wherein said threshold value is zero.

24. A method as claimed in claim 20, wherein said selection counter is a saturating counter having a maximum value and a minimum value between which said count value can vary without overflow.

25. A method as claimed in claim 20, wherein said increment value and said decrement value are dependent upon software controlled thread priority values.

26. A method as claimed in claim 20, wherein said increment value and said decrement value are dependent upon at least what type of operation was selected by said at least one steered stage.

27. A method as claimed in claim 21, wherein said plurality of selection counters are a plurality of saturating counters.
